(19) United States
(12) Patent Application Publication
(10) Pub. No.: US 2012/0052177 A1
(43) Pub. Date: Mar. 1, 2012

(54) FLAVORING MATERIAL

(76) Inventors: Yukiko Takakura, Kawasaki-shi (JP); Kazuhiro Hayashi, Kawasaki-shi (JP); Mayuko Iga, Kawasaki-shi (JP); Takuya Masuzawa, Kawasaki-shi (JP)

(21) Appl. No.: 13/241,524

(22) Filed: Sep. 23, 2011

Related U.S. Application Data
(63) Continuation of application No. PCT/JP2010/055995, filed on Mar. 25, 2010.

(30) Foreign Application Priority Data
Mar. 27, 2009 (JP) 078329/2009

(51) Int. Cl. A23L 1/231

(52) U.S. Cl. 426/535; 426/442

(57) ABSTRACT

An aroma or flavor-imparting composition containing methional, dienals and thiazoles in proportions satisfying 0≦A≦100, 0≦B≦100, 0≦C≦60 and A+B+C=100 wherein A shows parts by weight of methional, B shows parts by weight of dienals and C shows parts by weight of thiazoles. Foods containing these compositions, and method of imparting aroma or flavor to food are also described.

This application is a Continuation of, and claims priority under 35 U.S.C. §120 to, International Application No. PCT/JP2010/055995, filed Mar. 25, 2010, and claims priority therethrough under 35 U.S.C. §119 to Japanese Patent Application No. 2009-078329, filed Mar. 27, 2009, the entireties of which are incorporated by reference herein.

### BACKGROUND OF THE INVENTION

1. Field of the Invention

The present invention relates to compositions which can be used to impart aroma and/or flavor to a food, food or drink containing these compositions, and methods of imparting aroma or flavor to foods.

2. Brief Description of the Related Art

Livestock meat stock is used not only for soups (tan) in Chinese food, but also in Western cooking, such as in chicken bouillon, beef bouillon and the like, and is often a base ingredient for many foods. However, commercially available livestock meat extracts, and the like, readily deteriorate when heated during production; and therefore, the development of a seasoning having the natural flavor of livestock meat is desirable.

While the flavor components of livestock meat have been analyzed in some documents and the like (Food Research International, 34, 149, 2001, J. Agric. Food Chem., 53, 6455, 2005, J. Agric. Food Chem., 31, 1287, 1983), the quantification of such components have not been reported at present. Moreover, some patents and patent documents report the blending of livestock meat flavor (JP-B-03-38320, JP-2519264).

### SUMMARY OF THE INVENTION

According to current literature, flavor blends of compounds showed only a weak effect, exhibited additional undesirable aromas and the like, and a favorable livestock meat stock aroma or flavor was not imparted. In addition, flavor blends of compounds described in JP-B-03-38320 and JP-2519264 included additional aromas due to the as many as 12 or more compounds which were blended. Therefore, a favorable aroma or flavor was not imparted; and moreover, there was a problem of inconvenience caused by many compounds to be blended and the like.

With the above-mentioned background, it is an aspect of the present invention to provide a food material which can be more generally used, and can provide a strong aroma and/or flavor improving effect.

It is an aspect of the present invention to provide a composition comprising methional, dienal, and thiazole; wherein A is the weight percent of methional in said composition, B is the weight percent of dienal in said composition, and C is the weight percent of thiazole in said composition; and wherein 0≦A≦100, 0≦B≦100, 0≦C≦60, and A+B+C=100.

It is an aspect of the present invention to provide a composition comprising methional, dienal, and thiazole; wherein A is the weight percent of methional in said composition, B is the weight percent of dienal in said composition, and C is the weight percent of thiazole in said composition; and wherein 0≦A≦100, 0≦B≦100, 0≦C≦60, and A+B+C=100.

It is a further aspect of the present invention to provide a composition comprising methional, dienal, and thiazole; wherein A is the weight percent of methional in said composition, B is the weight percent of dienal in said composition, and C is the weight percent of thiazole in said composition; and wherein 20≦A≦80, 20≦B≦80, 0≦C≦40, and A+B+C=100.

It is a further aspect of the present invention to provide the composition as described above, wherein the dienal is selected from the group consisting of 2,4-decadienal, 2,4-heptadienal, 2,4-nonadienal, 2,4-undecadienal, and combinations thereof.

It is a further aspect of the present invention to provide the composition as described above, wherein the thiazole is selected from the group consisting of 2-isobutylthiazole 5-acetyl-2,4-dimethylthiazole, and combinations thereof.

It is a further aspect of the present invention to provide a food comprising the composition as described above, wherein said composition is present in said food in not less than 1 ppb and not more than 1 wt %.

It is a further aspect of the present invention to provide the food as described above, wherein the food is selected from the group consisting of livestock meat processed goods, livestock meat extract, chicken processed goods, and chicken extract.

It is a further aspect of the present invention to provide the food as described above, wherein said composition is present in said food in not less than 150 ppb and not more than 15 ppm.

It is a further aspect of the present invention to provide a method of imparting aroma and/or flavor to a food or drink comprising selecting a food or drink, and adding the composition as described above.

It is a further aspect of the present invention to provide the method as described above, wherein the food is selected from the group consisting of livestock meat processed goods, livestock meat extract, chicken processed goods, and chicken extract.

It is a further aspect of the present invention to provide the method as described above, wherein said composition is added to said food in an amount of not less than 1 ppb and not more than 1 wt % at the time of eating the food.

It is a further aspect of the present invention to provide the method as described above, wherein said composition is added to said food in an amount of not less than 150 ppb and not more than 15 ppm at the time of eating the food.

The present invention can provide a method of imparting aroma or flavor to food, particularly aroma or flavor like a livestock meat stock.

### BRIEF DESCRIPTION OF THE DRAWINGS

FIG. 1 is a triangular diagram showing the sensory evaluation results in soups, which are influenced by the proportion of each blended component in an aroma and flavor-imparting composition.

FIG. 2 is a simplified triangular diagram showing the sensory evaluation results in soups, which are influenced by the proportion of each blended component in an aroma and flavor-imparting composition.

### DESCRIPTION OF THE PREFERRED EMBODIMENTS

First, a livestock meat stock soup can be prepared according to cooking methods used generally in Chinese restaurants. The presence of an aroma component which is important for the livestock meat stock soup can be confirmed. Specifically, a water vapor distillate of a livestock meat stock soup and a reduced pressure distillate of a diethyl ether extract can be prepared, and the components can be confirmed mainly by gas chromatography—sniffing method.

It has been found that components such as methional, thiazoles, dienals, and the like can contribute to the aroma of a livestock meat stock soup. These 3 components can be quantified by a gas chromatography mass spectrometer (GC-MS). Based on the quantification results, livestock meat stocks such as chicken stock, pork stock, and the like can be reproduced with an aqueous solution, livestock meat soup, and extract. However, the aroma thereof was far from that of the original livestock meat stock soup.

Therefore, to solve the above-mentioned problem, a blend containing increased amounts of thiazoles and dienals, assuming that thiazoles are essential, can be attempted, rather than reproducing the blending amounts of methional, thiazoles and dienals.

The aroma or flavor-imparting composition can include methional, dienals, and thiazoles in proportions of 0≦A≦100, 0≦B≦100, 0≦C≦60, and A+B+C=100, wherein A can be parts by weight of methional, B can be parts by weight of dienals, and C can be parts by weight of thiazoles. As the concentrations deviate away from the above, an irritating and undesirable smell becomes stronger. Furthermore, a blending ratio of 20≦A≦80, 20≦B≦80, 0≦C≦40 and A+B+C=100 can be used, resulting in a stronger mixture, and the fleshy, livestock meat smell increases. When the composition as described herein is added to food and drink, a livestock meat stock aroma or flavor is imparted to the food and drink, and an enhanced aroma or flavor quality is provided to the food and drink as a whole.

The aroma as described here can mean an odor (top flavor) perceived only by the nose, in the absence of eating and drinking. In addition, the flavor as described herein can mean an odor (retro-nasal flavor) that passes from the oral cavity to the nose during eating and drinking.

Dienals are compounds having two double bonds and one aldehyde group, generically, and 2,4-decadienal, 2,4-heptadienal, 2,4-nonadienal, 2,4-undecadienal are specific examples, since they can impart a more livestock meat-like aroma.

Thiazole is a type of heterocyclic compound, and is also a generic term for compounds having a sulfur atom at the 1-position and a nitrogen atom at the 3-position of a 5-membered ring. 2-Isobutylthiazole and 5-acetyl-2,4-dimethylthiazole are specific examples, since they can impart a more livestock meat-like aroma.

The concentration at the time of eating can refer to the concentration at the specific time point of eating after cooking. The aroma or flavor-imparting composition can be present in food in not less than 1 ppb and not more than 1 wt % at the time of eating. Furthermore, in the concentration can be not less than 150 ppb and not more than 15 ppm. When the aroma or flavor-imparting composition is present in a food at a level lower than this, the cumulative effect is weak, and when contained at a level higher than this, an irritating smell becomes strong.

Materials which can be used in the aroma or flavor-imparting composition, particularly the composition that imparts a livestock meat stock aroma or flavor, can include synthesized products, extracted products, fermentation products, various materials after a heating reaction, and the like, as long as they are suitable for use in food and drink. The form of the material as described above is not particularly limited, and it can be a directly added to the aroma or flavor-imparting composition, added after diluting with water, solvent, and the like, mixed with a yeast extract, a livestock meat extract, a seafood extract, a protein hydrolysate etc., and the like.

When the aroma or flavor-imparting composition, particularly the composition that imparts livestock meat stock aroma or flavor, is added to a food, it can be in the form of a dry powder, a paste, a solution, and the like. In addition, the timing of when the composition is added to a food or a seasoning is not limited to before the production of the food or seasoning. The favorable effect of the livestock meat stock-like aroma or flavor can be obtained at any time during production, after completion, immediately before eating, during eating, and the like.

While the food and drink to which the aroma or flavor, particularly the livestock meat stock aroma or flavor, is imparted is not particularly limited, a more remarkable effect can be observed in food and drink using livestock meat processed goods and livestock meat extract, particularly chicken processed goods and chicken extract. Specifically, European foods such as chicken consomme soup, beef consomme soup, curry, beef stew, white stew, steak, hamburg steak, cutlet, and the like, Chinese foods such as Chinese soup, gyoza, shao-mai, fried rice, deep-fried food, and the like, Japanese-style foods such as Nikujaga, Chikuzenni (chicken stew with taro, carrot, burdock, etc.) and the like, various seasonings such as worcester sauce, demi-glace sauce, ketchup, various sauces and the like, flavor seasonings such as chicken soup mix, rice such as rice ball, pilaf and the like are specific examples.

While the present invention is further explained in the following by way of Examples, the technique scope of the present invention is not limited by these Examples. In the Examples, unless otherwise specified, the sensory evaluation was performed by sufficiently trained 4 expert panelists.

### EXAMPLES

### Example 1

### The Influence of the Concentration of Aroma and Flavor-Imparting Composition on Sensory Evaluation in Soups

Production of Chicken Stock

Whole chicken carcasses (cut in ¼) were parboiled for 1-2 min, and pre-treated by removing scum and internal organs. The pre-treated whole chicken carcasses (4 kg), welsh onion (28 g), ginger (38 g) and water (6.5 kg) were placed in a cylindrical container, heated to boil over high heat, and boiled well for 4 hr over low heat after boiling. The scum was removed during heating and boiling well as necessary. After boiling well for 4 hr, the resulting solution was filtered through a kitchen towel, and the oil floating on top of the filtered solution was skimmed therefrom. The remaining solution was used as a chicken stock.

Addition of various concentrations of savory or flavor-imparting compositions to chicken stock

To the chicken stock prepared above were added 2-isobutylthiazole, methional, and 2,4-decadienal at concentrations of 20%, 50% and 30%, respectively, such that the total concentration of the three components would be 1.57 ppb, 157 ppb, 15.7 ppm, 1570 ppm and 1.57%. Chicken stock free of the three components was used as a control.

For sensory evaluation, the preference of the livestock meat stock flavor was rated on a ten-point scale with the control as 5 points. The results are shown in Table 1.

TABLE 1
Table 1 Sensory evaluation of soups according to different
concentrations of aroma and flavor-imparting composition

| concentration of three components | | score |
|---|---|---|
| 1.57 | ppb | 5.8 |
| 157 | ppb | 6.2 |
| 15.7 | ppm | 6.0 |
| 1570 | ppm | 5.5 |

| | |
|---|---|
| 1.57% | 1.5 |
| control | 5.0 |

From the results of Table 1, the concentration of total three components of 1.57 ppb-1570 ppm imparted a favorable meat flavor. Furthermore, 157 ppb-15.7 ppm was found to be more favorable. When it was less than 1 ppb, the effect was unclear, and when it was 1.57%, the amount added was too much and off-flavors such as irritating smell and the like were observed.

### Example 2

### The Influence of Different Proportions of Each Blended Component in Aroma and Flavor-Imparting Composition on Sensory Evaluation in Soups

To the chicken stock prepared in Example 1 were added the three components of methional, 2,4-decadienal, and 2-isobutylthiazole at concentrations differing by 10%, such that the total concentration of the three components was 157 ppb. Chicken stock free of the three components was used as a control.

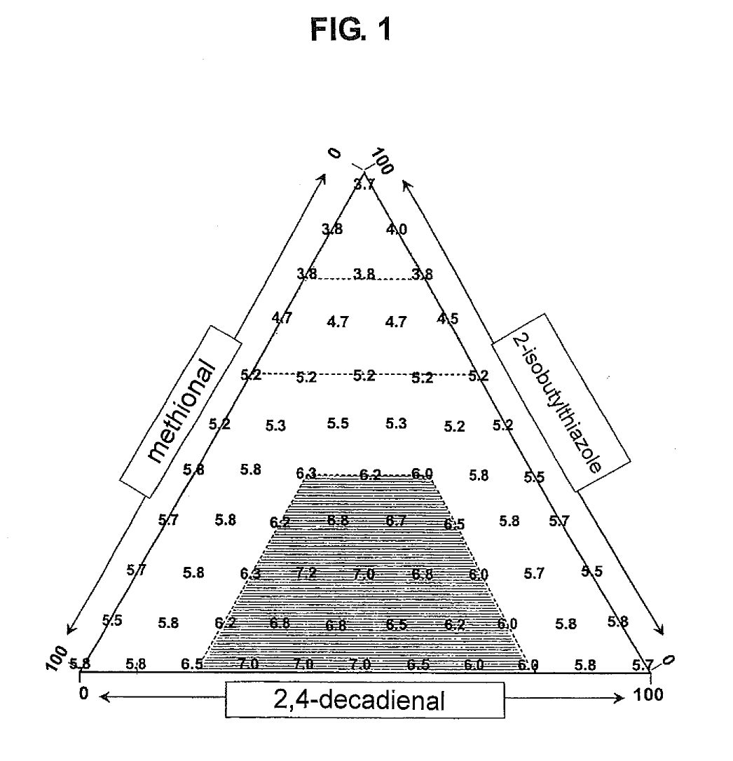

For sensory evaluation, the preference of the livestock meat stock flavor was rated on a ten-point scale with the control as 5 points. The results are shown in FIG. 1.

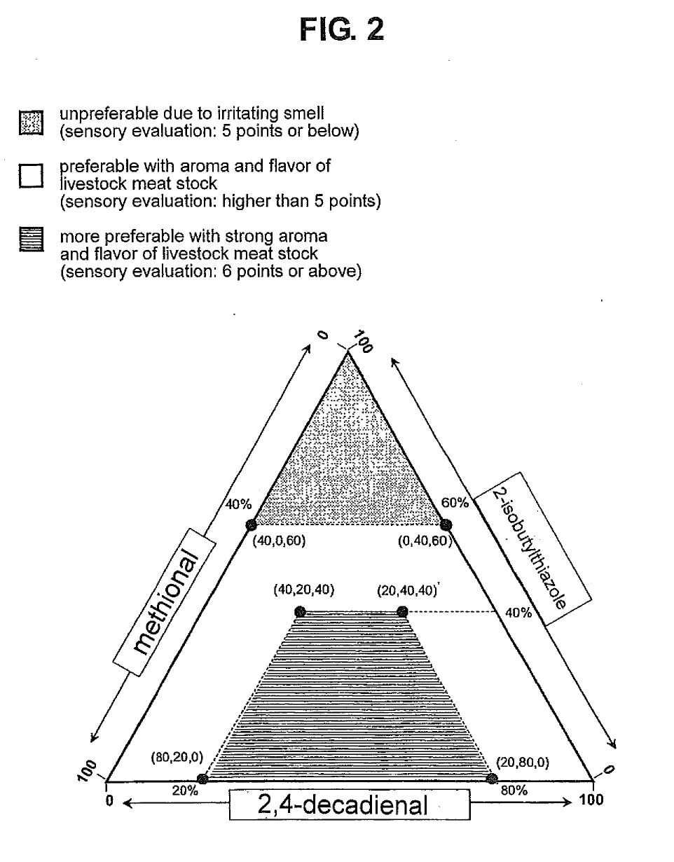

As is clear from the results of FIG. 1 and FIG. 2 summarizing FIG. 1, a favorable livestock meat stock flavor is imparted when the proportions of methional, 2,4-decadienal, and 2-isobutylthiazole are not less than 0% and not more than 100% of methional, not less than 0% and not more than 100% of 2,4-decadienal, and not less than 0% and not more than 60% of 2-isobutylthiazole, on the trilinear charts shown in FIG. 1 and FIG. 2 (plain parts in FIG. 1 and FIG. 2), as compared to the control. A more favorable meat flavor is imparted when not less than 20% and not more than 80% of methional, not less than 20% and not more than 80% of 2,4-decadienal, and not less than 0% and not more than 40% of 2-isobutylthiazole, on the trilinear charts shown in FIG. 1 and FIG. 2 (horizontally striped) parts in FIG. 1 and FIG. 2).

### Example 3

### Evaluation of Aroma and Flavor-Imparting Composition Using Various Thiazoles

To the chicken stock prepared in Example 1 were added methional, 2,4-decadienal, and various thiazoles at combined concentrations of 35%, 35% and 30%, respectively, such that the total concentration of the three components was 157 ppb. Chicken stock free of the three components was used as a control.

For sensory evaluation, comprehensive evaluation of the preference and strength of the livestock meat stock flavor was rated on a ten-point scale with the control as 5 points.

Various thiazoles and the results of sensory evaluation then are shown in Table 2.

TABLE 2
Table 2 Evaluation of aroma and flavor-imparting
composition using various thiazoles

| | sensory score |
|---|---|
| control | 5.0 |
| 2-isobutylthiazole | 9.2 |
| 4-methyl,5-vinylthiazole | 7.5 |
| 2-(methylthio)benzothiazole | 5.5 |
| benzothiazole | 7.3 |
| 2-acetylthiazole | 8.5 |
| 4,5-dimethylthiazole | 7.7 |
| 4-methylthiazole | 7.3 |
| 5-acetyl-2,4-dimethylthiazole | 8.7 |
| thiazole | 7.5 |
| 2-ethyl-4-methylthiazole | 7.7 |
| 2,4-dimethylthiazole | 7.7 |

From the results of Table 2, it has been clarified that various thiazoles shown in Table 2 impart a favorable livestock meat stock flavor. It has been further clarified that, from among various thiazoles, 2-isobutylthiazole and 5-acetyl-2,4-dimethylthiazole impart a particularly favorable livestock meat stock flavor.

### Example 4

### Evaluation of Aroma and Flavor-Imparting Composition Using Various Dienals

To the chicken stock prepared in Example 1 were added methional, various dienals, and 2-isobutylthiazole at combined concentrations of 50%, 30% and 20%, respectively, such that the total concentration of the three components was 157 ppb. Chicken stock free of the three components was used as a control.

For sensory evaluation, comprehensive evaluation of the preference and strength of the livestock meat stock flavor was rated on a ten-point scale with the control as 5 points.

Various dienals and the results of sensory evaluation then are shown in Table 3.

TABLE 3
Table 3 Evaluation of aroma and flavor-imparting
composition using various dienals

| | sensory score |
|---|---|
| control | 5.0 |
| trans,trans-2,4-heptadienal | 7.0 |
| trans,trans-2,4-nonadienal | 6.9 |
| trans-2,cis-6-nonadienal | 6.3 |
| trans,trans-2,4-decadienal | 7.0 |
| trans,trans-2,4-undecadienal | 6.8 |
| trans,trans-2,4-dodecadienal | 6.6 |

From the results of Table 3, it has been clarified that various dienals shown in Table 3 impart a favorable livestock meat stock flavor. It has been further clarified that, from among various dienals, the trans,trans form imparts a more favorable livestock meat stock flavor than does the trans,cis form. It has also been clarified that, from among the various dienals, 2,4-heptadienal, 2,4-nonadienal, 2,4-decadienal, and 2,4-undecadienal impart a particularly favorable livestock meat stock flavor.

### Example 5

### Influence on Sensory Evaluation of Aroma and Flavor-Imparting Composition in Pork Flavor Seasonings

Methional, dienal, and thiazole were added to a flavor seasoning containing a pork extract such that methional, dienal, and thiazole were 939 ppb, 40 ppb and 698 ppb, respectively. The mixture (5 g) was dissolved in 495 g of hot water and subjected to a sensory evaluation. As a result, the sample prepared by the addition of methional, dienal, and thiazole was imparted with a favorable livestock meat stock flavor, thickness and mildness as compared to the sample free of methional, dienal, and thiazole.

### Example 6

### Influence on Sensory Evaluation of Aroma and Flavor-Imparting Composition in Pork Flavor Seasonings

Methional, dienals, and thiazoles were added to a flavor seasoning containing a pork extract such that methional, dienal, and thiazole were 539 ppb, 40 ppb, and 699 ppb, respectively. The mixture (5 g) was dissolved in 495 g of hot water and subjected to a sensory evaluation. As a result, the sample prepared by the addition of methional, dienal, and thiazole was imparted with a favorable livestock meat stock flavor, a pleasant smell, spread, and richness, as compared to the sample free of methional, dienal, and thiazole.

### Example 7

### Influence on Sensory Evaluation of Aroma and Flavor-Imparting Composition in Pork Flavor Seasonings

Methional, dienal, and thiazole were added to a flavor seasoning containing a pork extract, such that methional, dienal, and thiazole were 784 ppb, 159 ppb and 1113 ppb, respectively. The mixture (5 g) was dissolved in 495 g of hot water and subjected to a sensory evaluation. As a result, the sample prepared by the addition of methional, dienal, and thiazole was imparted with a favorable livestock meat stock flavor and spread, and a further enhanced spice flavor of a flavor seasoning, as compared to the sample free of methional, dienals, and thiazoles.

### Example 8

### Influence on Sensory Evaluation of Aroma and Flavor-Imparting Composition in beef flavor seasonings

Methional, dienal, and thiazole were added to a flavor seasoning containing a beef extract such that methional, dienal, and thiazole were 3722 ppb, 44 ppb, and 4465 ppb, respectively. The mixture (5 g) was dissolved in 495 g of hot water and subjected to a sensory evaluation. As a result, the sample prepared by the addition of methional, dienal, and thiazole was imparted with a favorable livestock meat stock flavor and a meat-like thickness as compared to the sample free of methional, dienal, and thiazole.

### Example 9

### Influence on Sensory Evaluation of Aroma and Flavor-Imparting Composition in Beef Flavor Seasonings

Methional, dienal, and thiazole were added to a flavor seasoning containing a beef extract such that methional, dienal, and thiazole were 3682 ppb, 44 ppb and 4465 ppb, respectively. The mixture (5 g) was dissolved in 495 g of hot water and subjected to a sensory evaluation. As a result, the sample prepared by the addition of methional, dienal, and thiazole was imparted with a preferable livestock meat stock flavor, a meat-like thickness and a pleasant smell as compared to the sample free of methional, dienal, and thiazole.

### INDUSTRIAL APPLICABILITY

The present invention relates to a method of imparting aroma and flavor to food, particularly a method of imparting livestock meat stock-like aroma and flavor.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in their entireties.

1. A composition comprising methional, dienal, and thiazole;
wherein A is the weight percent of methional in said composition, B is the weight percent of dienal in said composition, and C is the weight percent of thiazole in said composition; and
wherein 20≦A≦80, 20≦B≦80, 0≦C≦40, and A+B+C=100.

2. The composition according to claim 1, wherein the dienal is selected from the group consisting of 2,4-decadienal 2,4-heptadienal, 2,4-nonadienal, 2,4-undecadienal, and combinations thereof.

3. The composition according to claim 1, wherein the thiazole is selected from the group consisting of 2-isobutylthiazole, 5-acetyl-2,4-dimethylthiazole, and combinations thereof.

4. A food comprising the composition according to claim 1, wherein said composition is present in said food in not less than 1 ppb and not more than 1 wt %.

5. A food comprising the composition of claim 2, wherein said composition is present in said food in not less than 1 ppb and not more than 1 wt %.

6. A food comprising the composition of claim 3, wherein said composition is present in said food in not less than 1 ppb and not more than 1 wt %.

7. The food according to claim 4, wherein the food is selected from the group consisting of livestock meat processed goods, livestock meat extract, chicken processed goods, and chicken extract.

8. A food comprising the composition according to claim 1, wherein said composition is present in said food in not less than 150 ppb and not more than 15 ppm.

9. A food comprising the composition according to claim 2, wherein said composition is present in said food in not less than 150 ppb and not more than 15 ppm.

10. A food comprising the composition according to claim 3, wherein said composition is present in said food in not less than 150 ppb and not more than 15 ppm.

11. The food according to claim 8, wherein the food is selected from the group consisting of livestock meat processed goods, livestock meat extract, chicken processed goods, and chicken extract.

12. The food according to claim 9, wherein the food is selected from the group consisting of livestock meat processed goods, livestock meat extract, chicken processed goods, and chicken extract.

13. The food according to claim 10, wherein the food is selected from the group consisting of livestock meat processed goods, livestock meat extract, chicken processed goods, and chicken extract.

14. A method of imparting aroma and/or flavor to a food or drink comprising selecting a food or drink, and adding the composition according to claim 1.

15. A method of imparting aroma and/or flavor to a food or drink comprising selecting a food or drink, and adding the composition according to claim 2.

16. A method of imparting aroma and/or flavor to a food or drink comprising selecting a food or drink, and adding the composition according to claim 3.

17. The method of claim 14, wherein said food is selected from the group consisting of livestock meat processed goods, livestock meat extract, chicken processed goods, and chicken extract.

18. The method of claim 15, wherein said food is selected from the group consisting of livestock meat processed goods, livestock meat extract, chicken processed goods, and chicken extract.

19. The method of claim 16, wherein said food is selected from the group consisting of livestock meat processed goods, livestock meat extract, chicken processed goods, and chicken extract.

20. The method according to claim 14, wherein said composition is added to said food in an amount of not less than 1 ppb and not more than 1 wt % at the time of eating the food.

21. The method according to claim 14, wherein said composition is added to said food in an amount of not less than 150 ppb and not more than 15 ppm at the time of eating the food.
